(19) United States
(12) Patent Application Publication
(10) Pub. No.: US 2020/0018492 A1
(43) Pub. Date: Jan. 16, 2020

(54) SYSTEM AND METHOD FOR A SMART CIRCULATOR FOR A HEAT SOURCE

(71) Applicant: Emerson Electric Co., St. Louis, MO (US)

(72) Inventors: David L. Perry, Arnold, MO (US); Randy T. Ruiz, St. Peters, MO (US); Chris J. Alexander, St. Peters, MO (US)

(21) Appl. No.: 16/031,704

(22) Filed: Jul. 10, 2018

(51) Int. Cl. F24D 19/10; F24B 1/187; F24D 5/02; G05D 23/19

(52) U.S. Cl. CPC F24D 19/1084; F24B 1/187; G05D 23/1934; G05D 23/1917; F24D 5/02

(57) ABSTRACT

A temperature control system and a method of controlling air conditioning in a multi-zone structure are disclosed. The temperature control system includes a forced-air primary conditioning unit including an air return duct, an air supply duct, and a circulator. The temperature control system also includes a secondary combustion heat source that operates independently of the forced-air primary conditioning unit, a smart circulator thermostat, and a remote temperature sensor. The at least one memory device includes executable instructions that when executed by the at least one processor cause the processor to receive a temperature value representative of a temperature of the structure, receive an indication of an operation of the secondary combustion heat source, generate a circulator operation signal based on a comparison of the received temperature value to a selectable temperature setpoint, and the received indication of an operation of an independent secondary combustion heat source.

### FIELD

The field of the disclosure relates generally to auxiliary heating systems, and, more particularly, to managing operation of an independent auxiliary combustion heating system with a forced-air furnace system.

### BACKGROUND

Some forced-air primary conditioning units are designed and installed with particular structures for the layout and orientation of the walls, rooms, and other interior spaces at the time of construction. Over time, remodeling of the building may cause walls and the like to be moved, new heat-loading equipment may be installed, and sources of auxiliary heating may also be installed. Typically, the forced-air primary conditioning unit and its ability to handle the increased or changed load is not revisited as the remodel is done. The changes often disrupt the heating and cooling patterns of the original design of the forced-air primary conditioning unit. Makeshift or ad hoc changes to the HVAC system may include changes to the ductwork, the addition of portable fans, opening windows, and re-aligning interior door positions are typical to restore proper balance to the forced-air furnace system. Obvious drawbacks to these methods include the temporary nature of the fix, the imprecise adjustments, and unintentional misalignment of the components.

This section is intended to introduce the reader to various aspects of art that may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

In one aspect, a temperature control system includes a forced-air primary conditioning unit configured to condition air in a plurality of spaces in a structure. The forced-air primary conditioning unit includes an air return duct, an air supply duct, and a circulator coupled in flow communication therebetween. The temperature control system also includes a secondary combustion heat source configured to condition air in a subset of spaces of the plurality of spaces and that operates independently of the forced-air primary conditioning unit. The secondary combustion heat source includes an indicator of operation of the secondary combustion heat source. The temperature control system further includes a smart circulator thermostat connected or communicatively coupled to a conditioning unit controller associated with the forced-air primary conditioning unit, and including a local temperature sensor and at least one processor communicatively coupled to at least one memory device. The temperature control system further includes a remote temperature sensor communicatively coupled to the at least one processor. The remote temperature sensor may be positioned so that it is spaced from the smart circulator thermostat in a heat-affected space of the secondary combustion heat source. The at least one memory device includes executable instructions that when executed by the at least one processor cause the processor to receive, at the smart circulator thermostat, a temperature value representative of a temperature of the structure, receive an indication of an operation of the secondary combustion heat source, generate, by the smart circulator thermostat, a circulator operation signal based on a comparison of the received temperature value to a selectable temperature setpoint, and based on the received indication of an operation of an independent secondary combustion heat source, and transmit the circulator operation signal to the circulator.

In another aspect, a method of controlling conditioning a multi-zone structure includes receiving, at a thermostat operable to control an operation of a forced-air primary conditioning unit coupled in flow communication with the multi-zone structure, a temperature value representative of a temperature of the multi-zone structure. The forced-air primary conditioning unit includes air return ducts, air supply ducts, and a circulator coupled in flow communication therebetween. The method includes receiving an indication of an operation of a secondary combustion heat source independent of the forced-air primary conditioning unit, generating, by the thermostat, a circulator operation signal based on a comparison of the received temperature value to a selectable setpoint, and based on the received indication of an operation of an independent secondary combustion heat source, and transmitting the circulator operation signal to the circulator.

In yet another aspect, a smart circulator thermostat includes a thermostat housing enclosing a thermostat device associated with a forced-air primary conditioning unit coupled in flow communication with a multi-zone structure, and a first temperature sensor, a remote temperature sensor communicatively coupled to the thermostat device. The remote temperature sensor is positionable spaced-apart from the thermostat device in a zone affected by heat from a secondary combustion heat source independent of the forced-air primary conditioning unit. The thermostat device is configured to receive, from the first temperature sensor, a temperature value representative of a temperature of the multi-zone structure. The forced-air primary conditioning unit includes air return ducts, air supply ducts, and a circulator coupled in flow communication therebetween. The thermostat device is further configured to receive an indication of an operation of the secondary combustion heat source. The thermostat device is also configured to generate a circulator operation signal based on a comparison of the received temperature value to a selectable setpoint, and based on the received indication of the operation of the secondary combustion heat source and transmit the circulator operation signal to the circulator.

Various refinements exist of the features noted in relation to the above aspects. Further features may also be incorporated in the aspects of the present disclosure as well as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIGS. 1-5 show example embodiments of the method and apparatus described herein.

FIG. 1 is a schematic block diagram of a temperature control system including a forced-air primary conditioning unit configured to condition air in a plurality of spaces in a multi-zone structure.

FIG. 2 is a schematic block diagram of the smart circulator thermostat shown in FIG. 1 in accordance with an example embodiment of the present disclosure.

FIG. 3 is a flow chart of a method of controlling a secondary fuel burning heat source in conjunction with a forced-air primary conditioning unit.

FIG. 4 is a simplified block diagram of an embodiment of the temperature control system shown in FIG. 1.

FIG. 5 is a flow chart of another method of controlling conditioning a multi-zone structure.

Although specific features of various embodiments may be shown in some drawings and not in others, this is for convenience only. Any feature of any drawing may be referenced and/or claimed in combination with any feature of any other drawing. Corresponding reference characters indicate corresponding parts throughout the drawings.

Unless otherwise indicated, the drawings are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. It is contemplated that the disclosure has general application to analytical and methodical embodiments of detecting occupancy in conditioned spaces in industrial, commercial, and residential applications.

Embodiments of a smart circulator controller described herein provide a thermostat for controlling a central forced air heating and/or cooling system having a wireless or wired remote sensor located in a room with a fuel burning appliance or heat source, such as a stove, space heater, or fireplace using wood, coal, gas, or other carbonaceous fuel that operates independently from the central forced air heating and/or cooling system. A room having the fuel burning appliance tends to be located in the vicinity of the thermostat in most typically constructed homes and similar buildings. This results in the thermostat not activating a call for heat, because the ambient temperature around the thermostat is above the heat setpoint, due to the heat generated by the fuel burning appliance. This results in other parts of the structure being below a desired temperature. This embodiment describes a method to compensate for this condition in a building having a central forced air HVAC system. The remote sensor transmits information to the thermostat with respect to the temperature in the room when the heat generating source is active. The remote sensor may be activated by a command from the thermostat, a mobile device, or via a signal from a gas burning control such as that used for modern gas stoves or fireplaces. Or, the input from the remote sensor may only be recognized when the thermostat is in “heat” mode. The remote sensor may send information to the thermostat regarding the temperature of the room, or it may have a set point programmed into it via a mobile device or a thermostat menu, such that when the temperature in the room exceeds the programmed set point, the remote sensor sends a signal to the thermostat that the set point has been reached. Conversely, the set point may be programmed into the thermostat via a mobile device, or a thermostat menu. In either case when the sensed temperature in the room reaches a predetermined level, the thermostat turns on the circulator of the central forced air heating and/or cooling system to distribute the heat from the stove or fireplace to other areas of the structure, such as, but not limited to other rooms. The circulator moves higher temperature air from the room and moves it to other areas of the structure thereby tending to equalize temperature throughout the multi-zone structure by lowering the temperature of the room containing the stove or fireplace and providing heat to those rooms not having a stove or fireplace.

The following description refers to the accompanying drawings, in which, in the absence of a contrary representation, the same numbers in different drawings represent similar elements.

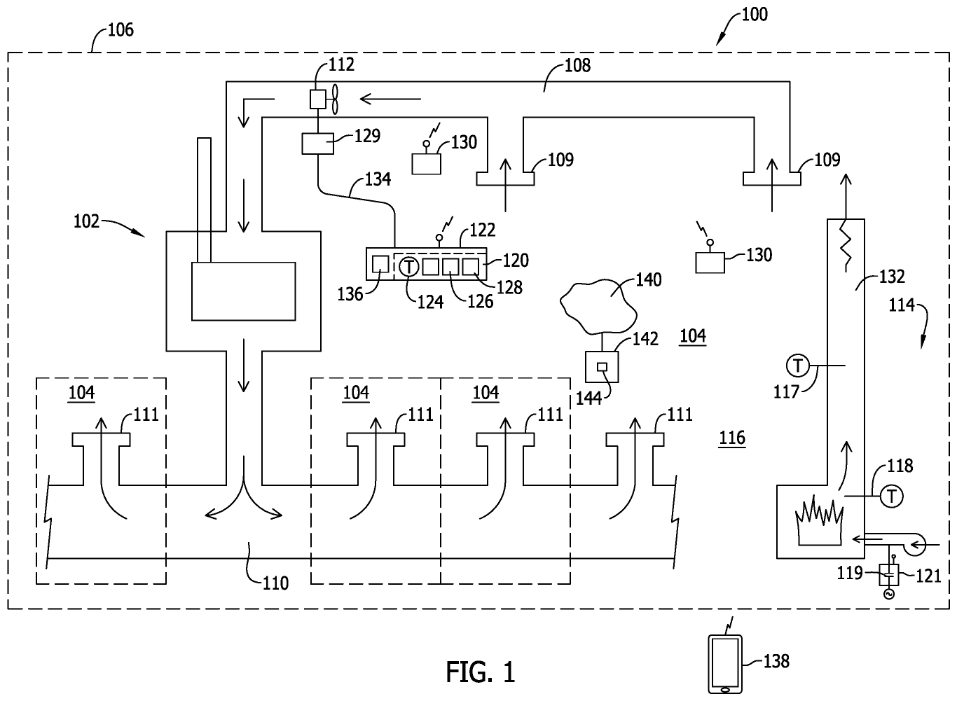

FIG. 1 is a schematic block diagram of temperature control system 100 including a forced-air primary conditioning unit 102 configured to condition air in a plurality of spaces 104 in a multi-zone structure 106. As used herein, zones may be embodied in rooms or areas of a larger space. Zones may or may not have separate controllable conditioned air supply valves. The forced-air primary conditioning unit 102 includes an air return duct 108, air return duct registers 109, a conditioned air supply duct 110, supply registers 111, and a circulator 112 coupled in flow communication therebetween. In various embodiments, temperature control system 100 includes a secondary fuel burning appliance or heat source 114, such as a wood or gas stove or fireplace that operates independently from forced-air primary conditioning unit 102. Although illustrated as a single secondary combustion heat source 114, secondary combustion heat source 114 may actually be embodied in a plurality of secondary combustion heat sources. For example, secondary combustion heat source 114 may represent one or more secondary combustion heat sources located in respective zones or rooms of structure 106. The plurality of spaces in multi-zone structure 106 includes, for example, rooms in multi-zone structure 106 and/or conditioning zones in multi-zone structure 106.

Secondary fuel burning heat source 114 is configured to condition air in a subset of spaces of the plurality of spaces 104. For example, a heat-affected space 116 immediately adjacent secondary fuel burning heat source 114 and spaces 104 nearby secondary fuel burning heat source 114, such as, spaces 104 that share a door or other opening between spaces 104 and heat-affected space 116. In the example embodiment, secondary fuel burning heat source 114, operates independently of forced-air primary conditioning unit 102. Also in the example embodiment, secondary fuel burning heat source 114 includes an indicator of operation of secondary fuel burning heat source 114, such as, but not limited to a flue temperature sensor 117, a combustion chamber temperature sensor 118, a contact 119 of a secondary fuel burning heat source fan controller 121, and combinations thereof.

Temperature control system 100 includes a smart circulator thermostat 120 communicatively coupled to a conditioning unit controller 122 associated with forced-air primary conditioning unit 102. In various embodiments, conditioning unit controller 122 includes a local temperature sensor 124 and at least one processor 126 communicatively coupled to at least one memory device 128. In various embodiments, at least one of smart circulator thermostat 120 and conditioning unit controller 122 includes a forced-air primary conditioning unit circulator interface 129 communicatively couplable to circulator 112.

Temperature control system 100 also includes a remote temperature sensor 130 communicatively coupled to at least one processor 126. Remote temperature sensor 130 is positionable spaced-apart from smart circulator thermostat 120 in heat-affected space 116 of secondary fuel burning heat source 114. In other embodiments, smart circulator thermostat 120 and remote temperature sensor 130 are located in separate spaces 104 of plurality of spaces 104 of multi-zone structure 106. Typically, smart circulator thermostat 120 is installed at the same time as forced-air primary conditioning unit 102 and is positioned optimally as determined at the time of installation. An optimal position is a position where the environment of spaces 104 is fairly represented by the sensed parameters of smart circulator thermostat 120. Smart circulator thermostat 120 may not be installed in an optimal position with respect to the additional heat that secondary fuel burning heat source 114 adds to spaces 104. Remote temperature sensor 130 can be used to facilitate evening out the heating of spaces 104 when secondary fuel burning heat source 114 is operating.

At least one memory device 128 includes executable instructions that when executed by at least one processor 126 cause at least one processor 126 to receive, at smart circulator thermostat 120, a temperature value representative of a temperature of multi-zone structure 106. Many factors may affect the ability of smart circulator thermostat 120 to receive the temperature value that is representative of a temperature of multi-zone structure 106, for example, stagnant pockets of air, open windows, sunlight heat loading, and the like. In some embodiments, smart circulator thermostat 120 may include remote temperature sensors to counter the detrimental effects and factors above. The executable instructions also cause at least one processor 126 to receive an indication of an operation of the secondary fuel burning heat source 114. Such indication may be provided by flue temperature sensor 117, which transmits a signal to at least one processor 126 when a temperature of a flue 132 of secondary fuel burning heat source 114 exceeds a predetermined threshold. Operation of the secondary fuel burning heat source 114 could also be ascertained using a gas detector, a flow detector, and the like.

The executable instructions also cause at least one processor 126 to generate a circulator operation signal 134 based on a comparison of the received temperature value to a selectable temperature setpoint, and based on the received indication of an operation of independent secondary fuel burning heat source 114, and to transmit circulator operation signal 134 to circulator 112.

In various embodiments, temperature control system 100 includes a user interface 136 communicatively coupled to at least one processor 126 and configured to receive the temperature setpoint selectable by a user. Processor 126 may communicate with a user through user interface 136, which may include a display embodied in, for example, a TFT LCD (Thin-Film-Transistor Liquid Crystal Display) or an OLED (Organic Light Emitting Diode) display, or other appropriate display technology. User interface 136 may receive commands from a user and convert them into a suitable format for submission to processor 126. In addition, an external interface 146 may be in communication with processor 126, so as to enable near area communication of smart circulator thermostat 120 with other devices. External interface 146 may provide, for example, for wired communication in some implementations, or for wireless communication in other implementations, and multiple interfaces may also be used.

Memory device 128 stores information within the smart circulator thermostat 120. Memory device 128 can be implemented as one or more of a computer-readable medium or media, a volatile memory unit or units, or a non-volatile memory unit or units. The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer or machine-readable medium, such as memory device 128, an expansion memory, or memory on processor 126 that may be received, for example, over external interface 146.

Smart circulator thermostat 120 may communicate wirelessly through communication interface 148, which may include digital signal processing circuitry where necessary. Communication interface 148 may provide for communications under various modes or protocols, such as GSM voice calls, SMS, EMS, or MMS messaging, CDMA, TDMA, PDC, WCDMA, CDMA2000®, or GPRS, among others. Such communication may occur, for example, through radio-frequency transceiver 150. In addition, short-range communication may occur, such as using a Bluetooth®, Wi-Fi®, or other such transceiver (not shown). In addition, Global Positioning system (GPS) receiver module 152 may provide additional navigation and location-related wireless data to smart circulator thermostat 120, which may be used as appropriate by applications running on smart circulator thermostat 120.

Smart circulator thermostat 120 may also communicate audibly using an audio codec, which may receive spoken information from a user and convert it to usable digital information. The audio codec may likewise generate audible sound for a user, such as through a speaker 154, e.g., in a faceplate of smart circulator thermostat 120. Such sound may include audible signals and recorded sound (e.g., voice messages, audible instructions or information, etc.) and may also include sound generated by applications operating on smart circulator thermostat 120.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for programmable processor 126, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

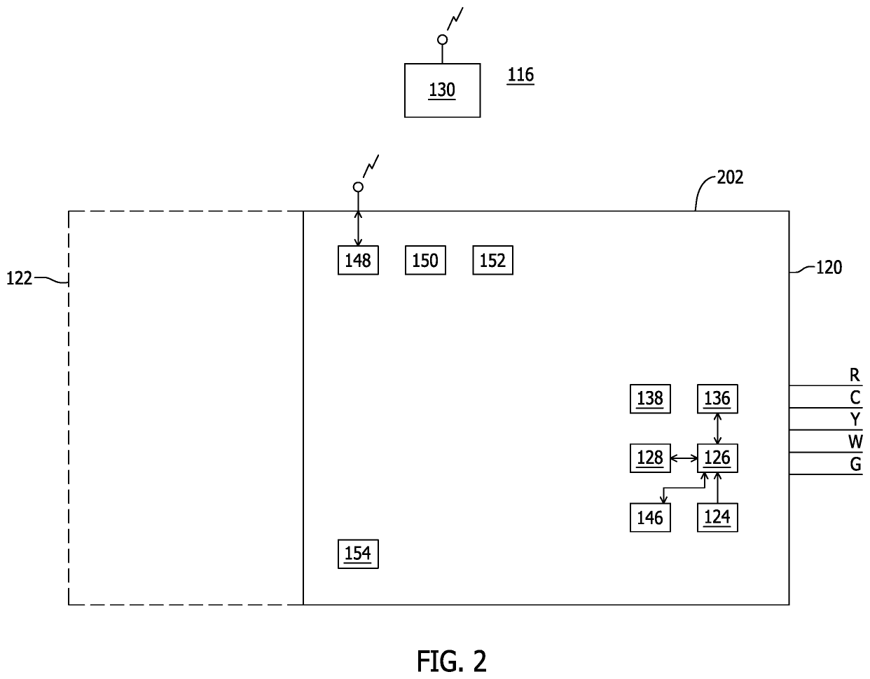

FIG. 2 is a schematic block diagram of smart circulator thermostat 120 (shown in FIG. 1) in accordance with an example embodiment of the present disclosure. In one embodiment, smart circulator thermostat 120 is a separate assembly from conditioning unit controller 122 and includes a thermostat housing 202 enclosing local temperature sensor 124. In other embodiments, smart circulator thermostat 120 forms a portion of conditioning unit controller 122. Smart circulator thermostat 120 and conditioning unit controller 122 are associated with forced-air primary conditioning unit 102, which is coupled in flow communication with multi-zone structure 106 (shown in FIG. 1). Remote temperature sensor 130 is positionable spaced-apart from the thermostat device in heat-affected zone 116 of secondary combustion heat source independent of forced-air primary conditioning unit 102 and is communicatively coupled to smart circulator thermostat 120 and/or conditioning unit controller 122. Smart circulator thermostat 120 is configured to receive, from local temperature sensor 124, a temperature value representative of a temperature of the multi-zone structure and to receive an indication of an operation of secondary fuel burning heat source 114 (shown in FIG. 1). Smart circulator thermostat 120 is also configured to generate circulator operation signal 134 based on a comparison of the received temperature value to a selectable setpoint, and based on the received indication of the operation of secondary fuel burning heat source 114. Smart circulator thermostat 120 is configured to transmit circulator operation signal 134 to circulator 112 (shown in FIG. 1) wirelessly or through a wired connection.

In various embodiments, smart circulator thermostat 120 includes at least one processor 126 communicatively coupled to at least one memory device 128, a user interface 136 communicatively coupled to at least one processor 126; and a forced-air primary conditioning unit circulator interface 129 communicatively coupled to circulator 112 of the forced-air primary conditioning unit 102. Smart circulator thermostat 120 is configured to receive one or more circulator operation setpoints via at least one of user interface 136 and wirelessly through, for example, a remote interface communicatively coupled to a smart phone, tablet, or other wireless device 138 of a user (shown in FIG. 1). The wireless communications may take place over a wireless network 140 (shown in FIG. 1), such as, but not limited to a local network or other networks, such as the Internet, a cloud network, or a smart home network that incorporates many other components for remote control, operation, and monitoring. Processor 126 can process instructions for execution within smart circulator thermostat 120, including instructions stored in memory device 128. Memory device 128 stores information within smart circulator thermostat 120. In one implementation, memory device 128 is a volatile memory unit or units. In another implementation, memory device 128 is a non-volatile memory unit or units.

In the example embodiment, circulator operation signal 134 may be embodied as a circulator run signal or a circulator stop signal depending on whether conditioning unit controller 122 or smart circulator thermostat 120 commands circulator 112 to run or stop. Smart circulator thermostat 120 is further configured to generate the circulator run signal when the received indication of the operation of secondary fuel burning heat source 114 indicates secondary fuel burning heat source 114 is operating and the temperature value representative of the temperature of multi-zone structure 106 is greater than a predetermined threshold for greater than a predetermined period of time.

Smart circulator thermostat 120 is further configured to control an operation of circulator 112 in conjunction with conditioning unit controller 122 associated with the forced-air primary conditioning unit 102. Remote temperature sensors 130 are communicatively coupled to conditioning unit controller 122 and/or smart circulator thermostat 120 spaced-apart from smart circulator thermostat 120 and each other in respective zones of multi-zone structure 106.

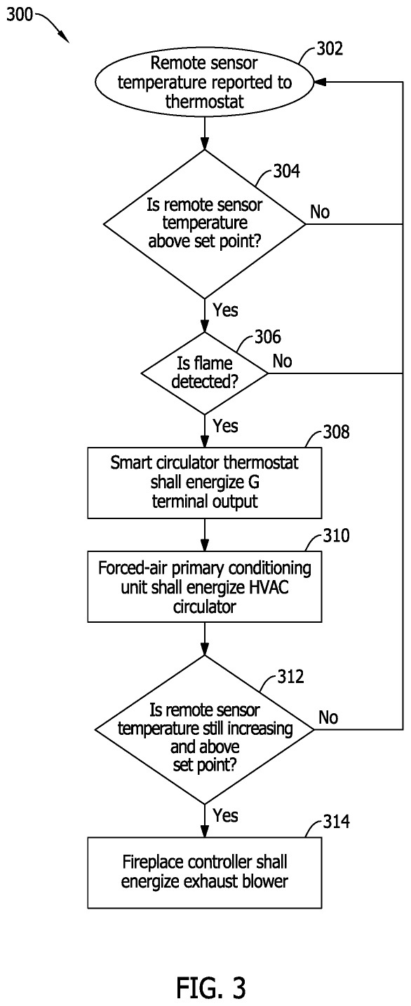

FIG. 3 is a flow chart of a method 300 of controlling a secondary fuel burning heat source in conjunction with a forced-air primary conditioning unit. In the example embodiment, remote temperature sensor 130 reports 302 a temperature value proximate to remote temperature sensor 130 to smart circulator thermostat 120. The reported temperature value is compared 304 to a predetermined setpoint or threshold range. If the reported temperature value is below the predetermined setpoint, the circulator does not need to be turned on. Processing returns to block 302. If the reported temperature value is above or equal to the predetermined setpoint, circulator operation is called for to even the temperatures throughout the multi-zone structure. Method 300 then detects 306 whether the secondary fuel burning heat source is operating using, for example, a flame detector. Other parameters may be measured or observed that indicate whether the secondary fuel burning heat source is operating. For example, a temperature of the combustion chamber, a temperature of the flue gas exiting the combustion chamber, or a contact of a secondary combustion heat source fan controller can indicate that the secondary fuel burning heat source is operating. If the secondary fuel burning heat source is determined to be not operating, processing returns to block 302. If the secondary fuel burning heat source is determined 308 to be operating, the smart circulator thermostat energizes 310 the “G” terminal output. By convention, the “G” terminal controls the fan relay of the forced-air primary conditioning unit and is responsible for turning the blower fan or circulator on and off automatically or manually via the smart circulator thermostat. When the circulator starts operation, air is circulated throughout the multi-zone structure through the existing ductwork of the forced-air primary conditioning unit. Such circulation mixes warmer air in the heat-affected areas with cooler air in spaces more remote from the secondary combustion heat source. Method 300 checks 312 one or more of the plurality of remote temperature sensors. If the temperature is still increasing after a predetermined period of time and still above the setpoint, the secondary fuel burning heat source fan controller energizes 314 an exhaust fan, reduces power to a forced draft fan associated with the secondary fuel burning heat source, and/or closes down on an air supply damper to secondary fuel burning heat source. These measures reduce the amount of heat entering the multi-zone structure until the effects of operating the circulator are able to reduce the heating in the multi-zone structure.

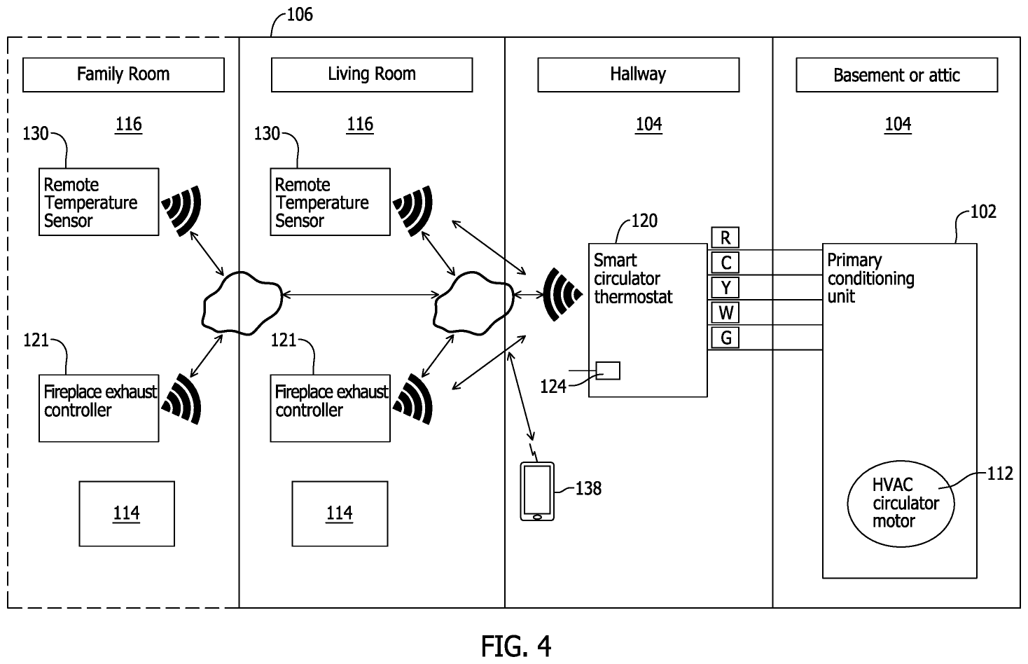

FIG. 4 is a simplified block diagram of an embodiment of temperature control system 100 (shown in FIG. 1). In the example embodiment, multi-zone structure 106 is illustrated with three spaces, a basement or attic space 104 where forced-air primary conditioning unit 102 is located, a hallway space 104 where smart circulator thermostat 120 is located, and a living room space 116, which is a heat-affected zone proximate secondary fuel burning heat source 114.

During operation, smart circulator thermostat 120 controls the operation of forced-air primary conditioning unit 102 by cycling forced-air primary conditioning unit 102 on and off according to a heating demand sensed by smart circulator thermostat 120 in the hallway. At certain times, a user may operate secondary fuel burning heat source 114 to provide ambience to the living room or to supplement the heating capabilities of forced-air primary conditioning unit 102. Because smart circulator thermostat 120 may not adequately sense the extra heat being added to the living room, the living room may become too warm for comfort.

Remote temperature sensor 130 reports the temperature in the zone surrounding remote temperature sensor 130 to smart circulator thermostat 120. Smart circulator thermostat 120 analyzes the temperature data and determines whether circulator 112 should be employed to even out the temperature in multi-zone structure 106. If so, smart circulator thermostat 120 energizes the “G” terminal to circulator 112. Circulator 112 operates to circulate air throughout multi-zone structure 106 using the existing ductwork of forced-air primary conditioning unit 102. Circulator 112 operates independently of a call for heat by smart circulator thermostat 120 based on the temperature locally from local temperature sensor 124. Remote temperature sensor 130 continues to report temperatures in heat-affected zone 116. If the temperature reported by remote temperature sensor 130 is above the predetermined setpoint for a predetermined period of time and the trend of the temperature is increasing over time, smart circulator thermostat 120 will also energize the “G” terminal to start circulator operation.

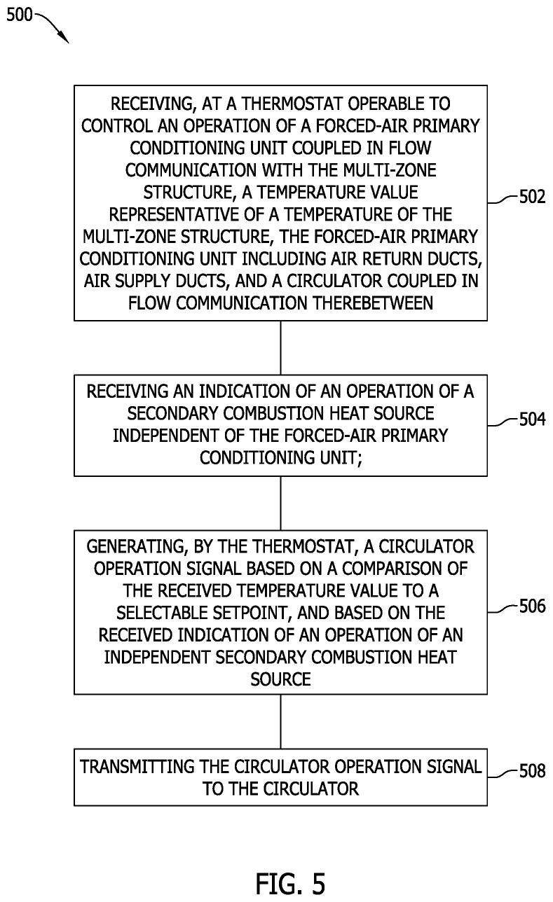

FIG. 5 is a flow chart of another method 500 of controlling conditioning a multi-zone structure. In the example embodiment, method 500 includes receiving 502, at a thermostat operable to control an operation of a forced-air primary conditioning unit coupled in flow communication with the multi-zone structure, a temperature value representative of a temperature of the multi-zone structure. In various embodiments, the forced-air primary conditioning unit includes air return ducts, air supply ducts, and a circulator coupled in flow communication therebetween. Method 500 also includes receiving 504 an indication of an operation of a secondary combustion heat source independent of the forced-air primary conditioning unit and generating 506, by the thermostat, a circulator operation signal based on a comparison of the received temperature value to a selectable setpoint, and based on the received indication of an operation of an independent secondary combustion heat source. Method 500 also includes transmitting 508 the circulator operation signal to the circulator.

Wireless devices 138 may include any devices capable of receiving information from. Wireless devices 138 could include general computing components and/or embedded systems optimized with specific components for performing specific tasks. Examples of user access devices include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. Wireless devices 138 can also include various other elements, such as processes running on various machines.

Network 140 may include any element or system that facilitates communications among and between various network nodes, such as elements 120, 121, 122, 130, and 138. Network 140 may include one or more telecommunications networks, such as computer networks, telephone or other communications networks, the Internet, etc. Network 140 may include a shared, public, or private data network encompassing a wide area (e.g., WAN) or local area (e.g., LAN). In some implementations, network 140 may facilitate data exchange by way of packet switching using the Internet Protocol (IP). Network 140 may facilitate wired and/or wireless connectivity and communication.

Temperature control system 100 may further include a website 142 including one or more resources 144 (e.g., text, images, multimedia content, and programming elements, such as scripts) associated with a domain name and hosted by one or more servers. Resources 144 can be relatively static (e.g., as in a temperature control system monitoring webpage) or dynamically generated in response to user interactions (e.g., as in a control and/or troubleshooting webpage).

The foregoing detailed description illustrates embodiments of the disclosure by way of example and not by way of limitation. It is contemplated that the disclosure has general application to temperature control of structures having a plurality of rooms and/or zones that are affected differently by various heat and sink sources. It is further contemplated that the methods and systems described herein may be incorporated into existing HVAC systems, in addition to being maintained as a separate stand-alone application.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “wireless device” refers to any computing device which is used in a portable manner including, without limitation, smart phones, personal digital assistants (“PDAs”), computer tablets, hybrid phone/computer tablets (“phablet”), or other similar mobile computing device capable of functioning in the systems described herein. In some examples, wireless devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably with “wireless device.”

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 126 and by devices that include, without limitation, mobile devices, clusters, personal computers, workstations, clients, and servers, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, the technical effect of the methods and systems may be achieved by performing at least one of the following steps: (a) receiving, at a thermostat operable to control an operation of a forced-air primary conditioning unit coupled in flow communication with the multi-zone structure, a temperature value representative of a temperature of the multi-zone structure, (b) receiving an indication of an operation of a secondary combustion heat source independent of the forced-air primary conditioning unit, (c) generating, by the thermostat, a circulator operation signal based on a comparison of the received temperature value to a selectable setpoint and on the received indication of an operation of an independent secondary combustion heat source, and transmitting the circulator operation signal to the circulator.

Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing(s) shall be interpreted as illustrative and not in a limiting sense.

What is claimed is:

1. A smart circulator thermostat comprising:
a thermostat housing enclosing a thermostat device associated with a forced-air primary conditioning unit coupled in flow communication with a multi-zone structure, and a first temperature sensor;
a remote temperature sensor communicatively coupled to the thermostat device, the remote temperature sensor positionable spaced-apart from the thermostat device in a zone affected by heat from a secondary combustion heat source independent of the forced-air primary conditioning unit,
the thermostat device is configured to:
receive, from the first temperature sensor, a temperature value representative of a temperature of the multi-zone structure, the forced-air primary conditioning unit comprising air return ducts, air supply ducts, and a circulator coupled in flow communication therebetween;
receive an indication of an operation of the secondary combustion heat source;
generate a circulator operation signal based on a comparison of the received temperature value to a selectable setpoint, and based on the received indication of the operation of the secondary combustion heat source; and
transmit the circulator operation signal to the circulator.

2. The smart circulator thermostat of claim 1, wherein the thermostat device comprises at least one processor communicatively coupled to at least one memory device, a user interface communicatively coupled to the at least one processor; and a forced-air primary conditioning unit circulator interface communicatively couplable to a circulator of the forced-air primary conditioning unit.

3. The smart circulator thermostat of claim 2, wherein the thermostat device is further configured to receive one or more circulator operation setpoints via at least one of the user interface and wirelessly.

4. The smart circulator thermostat of claim 1, wherein the circulator operation signal comprises a circulator run signal and a circulator stop signal, the thermostat device is further configured to generate a circulator run signal when the received indication of the operation of the combustion heat source indicates the secondary combustion heat source is operating and the temperature value representative of the temperature of the multi-zone structure is greater than a predetermined threshold for greater than a predetermined period of time.

5. The smart circulator thermostat of claim 1, wherein the thermostat device is further configured to control an operation of the circulator in conjunction with a conditioning unit controller associated with the forced-air primary conditioning unit.

6. The smart circulator thermostat of claim 1, further comprising a plurality of remote temperature sensors communicatively coupled to the thermostat device, the plurality of remote temperature sensors positionable spaced-apart from the thermostat device and each other in respective zones of the multi-zone structure.

7. The smart circulator thermostat of claim 1, wherein the secondary combustion heat source comprises a plurality of secondary combustion heat source spaced-apart from each other in respective zones of the multi-zone structure.

8. A method of controlling conditioning a multi-zone structure, the method comprising:
receiving, at a thermostat operable to control an operation of a forced-air primary conditioning unit coupled in flow communication with the multi-zone structure, a temperature value representative of a temperature of the multi-zone structure, the forced-air primary conditioning unit including air return ducts, air supply ducts, and a circulator coupled in flow communication therebetween;
receiving an indication of an operation of one or more secondary combustion heat sources that are each independent of the forced-air primary conditioning unit;
generating, by the thermostat, a circulator operation signal based on a comparison of the received temperature value to a selectable setpoint, and based on the received indication of an operation of the one or more independent secondary combustion heat sources; and
transmitting the circulator operation signal to the circulator.

9. The method of claim 8, further comprising receiving a plurality of temperature values combinable into a bulk temperature value representative of the temperature of the multi-zone structure.

10. The method of claim 8, wherein receiving an indication of an operation of a secondary combustion heat source independent of the forced-air primary conditioning unit comprises receiving, by the thermostat, at least one of a secondary combustion heat source temperature indication and a remote temperature sensor temperature indication, the remote temperature sensor positioned remotely from the thermostat and proximate the secondary combustion heat source.

11. The method of claim 8, wherein transmitting the circulator operation signal to the circulator comprises transmitting the circulator operation signal directly to the circulator.

12. The method of claim 8, wherein transmitting the circulator operation signal to the circulator comprises transmitting the circulator operation signal to the circulator via the forced-air primary conditioning unit.

13. The method of claim 8, wherein receiving an indication of an operation of a secondary combustion heat source comprises receiving an indication of the operation of the secondary combustion heat source wirelessly.

14. The method of claim 8, wherein receiving an indication of an operation of a secondary combustion heat source independent of the forced-air primary conditioning unit comprises determining that the secondary combustion heat source is operating using at least one of a temperature sensor in a flue of the secondary combustion heat source, a temperature sensor in a combustion chamber of the secondary combustion heat source, an output of a secondary combustion heat source controller.

15. The method of claim 8, wherein generating, by the thermostat, a circulator operation signal comprises generating, by the thermostat, a circulator run signal when the received indication of the operation of the combustion heat source indicates the secondary combustion heat source is operating and the temperature value representative of the temperature of the multi-zone structure is greater than a predetermined threshold for greater than a predetermined period of time.

16. A temperature control system comprising:
a forced-air primary conditioning unit configured to condition air in a plurality of spaces in a structure, the forced-air primary conditioning unit comprising an air return duct, an air supply duct, and a circulator coupled in flow communication therebetween;
one or more secondary combustion heat sources configured to condition air in a subset of spaces of the plurality of spaces and that operates independently of the forced-air primary conditioning unit, the one or more secondary combustion heat sources including an indicator of operation of the secondary combustion heat source;
a smart circulator thermostat communicatively coupled to a conditioning unit controller associated with the forced-air primary conditioning unit, and including a local temperature sensor and at least one processor communicatively coupled to at least one memory device; and
a remote temperature sensor communicatively coupled to the at least one processor, the remote temperature sensor positionable spaced-apart from the smart circulator thermostat in a heat affected space of the one or more secondary combustion heat sources,
the at least one memory device comprises executable instructions that when executed by the at least one processor cause the processor to:
receive, at the smart circulator thermostat, a temperature value representative of a temperature of the structure,
receive an indication of an operation of the one or more secondary combustion heat sources;
generate, by the smart circulator thermostat, a circulator operation signal based on a comparison of the received temperature value to a selectable temperature setpoint, and based on the received indication of an operation of the one or more independent secondary combustion heat sources; and
transmit the circulator operation signal to the circulator.

17. The temperature control system of claim 16, wherein the plurality of spaces in the structure include at least one of rooms in the structure and conditioning zones in the structure.

18. The temperature control system of claim 16, wherein the indicator of operation of the one or more secondary combustion heat sources comprises at least one of a flue temperature sensor, a combustion chamber temperature sensor, and a contact of a secondary combustion heat source fan controller.

19. The temperature control system of claim 16, wherein the smart circulator thermostat includes a forced-air primary conditioning unit circulator interface connected to the circulator.

20. The temperature control system of claim 16, further comprising a user interface connected to the at least one processor and configured to receive the temperature setpoint selectable by a user.

21. The temperature control system of claim 16, wherein the smart circulator thermostat and the remote temperature sensor are located in separate spaces of the plurality of spaces of the structure.
